(19) United States
(12) Patent Application Publication
(10) Pub. No.: US 2008/0264242 A1
(43) Pub. Date: Oct. 30, 2008

(54) PHASE SHIFTING DEVICE IN ELECTRONIC MUSICAL INSTRUMENT

(76) Inventor: Hiromi MURAKAMI, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 12/101,560

(22) Filed: Apr. 11, 2008

(30) Foreign Application Priority Data
Apr. 12, 2007 (JP) 2007-104598

(51) Int. Cl. G10H 3/18

(52) U.S. Cl. 84/726

(57) ABSTRACT

It is an object of the invention to provide a phase switching device in an electric musical instrument capable of outputting a sound wave, which is output from the electric musical instrument, in a positive phase. A detection means that detects whether a sound wave transmitted from an electric musical instrument has a positive phase or a negative phase and a phase inverting means that inverts the phase of the sound wave from the electric musical instrument to a positive phase when a result of detection performed by the detection means is a negative phase are provided. An inversion operation driving means that causes the phase inverting means to perform an inversion operation on the basis of a detection signal when the result detected by the detection means is a negative phase is provided between the detection means and the phase inverting means.

### BACKGROUND OF THE INVENTION

1. Field of the Invention

The present invention relates to a phase switching device in an electric (electronic) musical instrument, such as electric stringed instruments including an electric guitar and an electric bass guitar.

2. Description of the Related Art

An electric stringed instrument, which is an example of an electric (electronic) musical instrument, includes a pickup that detects vibration of strings and converts the detected vibration into an electric signal. A power generation effect obtained by using a magnet and a coil is used in the pickup, and there are two kinds of voltages of electric signals output in a manufacturing process or in a design stage, that is, a plus output and a minus output. In addition, amplifiers for amplifying the electric signal include an amplifier that outputs an input signal without changing the phase, that is, outputs an input signal in a positive phase if the signal has the positive phase at the time of input and outputs an input signal in a negative phase if the signal has the negative phase at the time of input and an amplifier that outputs an input signal with the phase inverted, that is, outputs an input signal in a negative phase if the signal has the positive phase at the time of input and outputs an input signal in a positive phase if the signal has the negative phase at the time of input.

The situations are shown in FIGS. 4(a) and 4(b). That is, in FIG. 4(a), a negative-phase signal from a pickup 51, which is configured to include a magnet and a coil, serving to detect vibration of a string 50 is input to a musical instrument amplifier 52 (in this case, an input signal is output without being inverted in a circuit) and is then output as a sound wave 55R propagating from a speaker 54, which is provided within a rear surface open type speaker box 53 connected to the musical instrument amplifier 52, backward from a sound checking position.

In addition, in FIG. 4(b), a positive-phase signal from the pickup 51 is input to the musical instrument amplifier 52 (in this case, an input signal is output without being inverted in a circuit) and is then output as a sound wave 55 propagating from the speaker 54, which is provided within the rear surface open type speaker box 53 connected to the musical instrument amplifier 52, to a side of the sound checking position, that is, propagating forward from the speaker 54. A bass drum 56 is disposed beside the speaker 54, and a state where a sound wave 57 propagating to the sound checking position side, that is, propagating forward is generated by striking an upper drumhead is shown.

As described above, listening to the sound wave 55R propagating backward from the speaker 54 while listening to the sound wave 57 propagating forward from the bass drum 56 as shown in FIG. 4(a) was so uncomfortable, which left much room for improvement. Particularly in the case of a band performance, it is difficult to catch inversion of a phase in a situation where sound waves from many speakers are mixed. In actuality, when a sound is thought to be abnormal, at least a balance is adjusted by adjusting a sound volume and the like. However, this was not sufficient. In addition, it has already been proposed to provide a sound signal control circuit for balancing of a stereophonic reproduction sound in order to increase spreading feeling of the stereophonic reproduction sound and secure a level balance of a low-pitched sound portion, a middle-pitched sound portion, and a high-pitched sound portion in the reproduction sound (for example, refer to JP-A-9-162664).

### DISCLOSURE OF INVENTION

### Problems to be Resolved by the Invention

The sound signal control circuit disclosed in JP-A-9-162664 is provided to secure a level balance of a reproduction sound from an audio apparatus, for example, but does not serve to convert all phases into positive phases. Accordingly, a sound wave from the above-described electric musical instrument cannot be output forward. This was so uncomfortable in the case where a band plays live.

The invention has been finalized in view of the above situation, and it is an object of the invention to provide a phase switching device in an electric musical instrument capable of outputting a sound wave, which is output from the electric musical instrument, in a positive phase.

### Means of Solving the Problems

To achieve the above objects, according to an aspect of the invention, a phase switching device in an electric musical instrument includes: a detection means that detects whether a sound wave transmitted from the electric musical instrument has a positive phase or a negative phase; and a phase inverting means that inverts the phase of the sound wave from the electric musical instrument to a positive phase when a result of detection performed by the detection means is a negative phase.

Thus, by using the phase inverting means only when the detection means detects that the sound wave transmitted from the electric musical instrument is a negative phase, the phase of the sound wave can be inverted to the positive phase.

The detection means may include: a non-inverting circuit connected to an input line to which a sound wave from the electric musical instrument is input; an inverting circuit which branches from the input line and is connected thereto and is connected in parallel with the non-inverting circuit; rectifier diodes connected to output portions of the non-inverting circuit and inverting circuit, respectively; two inverter circuits connected in series to each other so that signals rectified in the rectifier diodes can be inverted to be output; flip-flop circuits respectively connected to output portions of the inverter circuits located at the output side; and two light emitting diodes that are turned on or off by output signals from the flip-flop circuits.

The phase inverting means may include: a non-inverting circuit connected to an input line to which a sound wave from the electric musical instrument is input; an inverting circuit connected in parallel with the non-inverting circuit; and a switching switch provided to output only one of output signals from the non-inverting circuit and the inverting circuit.

A musical instrument amplifier for amplifying a signal, which is output after being switched by the switching switch, and outputting the signal to a side of the detection means may be further included.

A detection state holding means that holds a corresponding detection state until a reset signal is input in the case when the detection means detects the positive phase or the negative phase may be further included.

Each of the flip-flop circuits may be a D flip-flop circuit which operates when a rising voltage of a clock signal exceeds a threshold value by an input sound wave to thereby output a high signal and turn on the light emitting diodes. The detection state holding means may include: an output terminal that is provided at an output side of each of the D flip-flop circuits in order to invert a high-level output, which is set before application of a rising voltage, to a low-level output by applying the rising voltage; and a transistor that is connected between the output terminal and an output portion of the inverter circuit and is turned on by inversion to the low-level output so that a clock signal input to each of the flip-flop circuits can flow to the ground.

An inversion operation driving means that causes the phase inverting means to perform an inversion operation on the basis of a detection signal when the result detected by the detection means is a negative phase may be provided between the detection means and the phase inverting means.

The inversion operation driving means may include: an inverter circuit which inverts and outputs an output signal from one flip-flop circuit; an AND circuit to which an output signal from the inverter circuit and an output signal from the other flip-flop circuit are input; and a relay for performing a switching operation of the switching switch by a ‘high’ signal output from the AND circuit.

### Advantageous Effect of the Invention

Since it is possible to provide the phase switching device in the electric musical instrument in which the detection means can detect whether a sound wave transmitted from the electric musical instrument has a positive phase or a negative phase and the phase inverting means can invert the phase of the sound wave to a positive phase in the case of a negative phase, a band can play live in a comfortable state.

In the case where the detection means includes the non-inverting circuit connected to the input line to which the sound wave from the electric musical instrument is input, the inverting circuit which branches from the input line and is connected thereto and is connected in parallel with the non-inverting circuit, the rectifier diodes connected to output portions of the non-inverting circuit and inverting circuit, respectively, the two inverter circuits connected in series to each other so that signals rectified in the rectifier diodes can be inverted to be output, the flip-flop circuits respectively connected to output portions of the inverter circuits located at the output side, and the two light emitting diodes that are turned on or off by output signals from the flip-flop circuits, it can be immediately checked whether the sound wave transmitted from the electric musical instrument has a positive phase or a negative phase on the basis of a lighting situation of the two light emitting diodes.

In the case where the detection state holding means for holding a corresponding detection state until a reset signal is input when the detection means detects the positive phase or the negative phase is provided, it is advantageous in that the detection means can be prevented from malfunctioning due to signals that are unnecessarily input repeatedly.

In the case where there is provided the inversion operation driving means between the detection means and the phase inverting means to cause the phase inverting means to perform an inversion operation on the basis of a detection signal when the result detected by the detection means is a negative phase, it is advantageous in that the phase inverting means can be quickly operated and an erroneous operation can be prevented, as compared with a configuration in which the phase inverting means is manually operated after checking a result of detection performed by the detection means.

### BRIEF DESCRIPTION OF THE DRAWINGS

FIG. 1 is an electric circuit diagram illustrating the specific configuration of a detection means and a phase inverting means;

FIG. 2 is an electric circuit diagram illustrating a state where a sound wave having a negative phase is input to the circuit shown in FIG. 1;

FIG. 3 is an electric circuit diagram illustrating a state where an inversion operation driving circuit is added to the circuit diagram shown in FIG. 2;

FIG. 4(a) is an explanatory view schematically illustrating a direction in which a sound wave propagates forward; and

FIG. 4(b) is an explanatory view schematically illustrating a direction in which a sound wave propagates backward.

### DESCRIPTION OF THE REFERENCE CODES

1: electric musical instrument, 2: detection means, 3: phase inverting means (phase switching unit), 4: microphone, 5: amplitude amplifier, 6: input line, 7: non-inverting circuit, 8: inverting circuit, 9, 10, 11, 12: inverter circuits, 13, 14: flip-flop circuits, 15, 16: light emitting diodes, 17: input line, 18: non-inverting circuit, 19: inverting circuit, 20: switching switch, 21: musical instrument amplifier, 22: speaker, 23: speaker mounting amplifier, 24: detection state holding means, 25, 26: output terminals, 27: transistor, 28: reset switch 29: inversion operation driving means, 30: inverter circuit, 31: AND circuit, 32: relay, 50: string, 51: pickup, 52: musical instrument amplifier, 53: rear surface open type speaker box, 54: speaker, 55, 55R: sound waves, 56: bass drum, 57: sound wave, D1, D2: rectifier diodes, D3, D4: backflow preventing diodes, R, R1, R11, R12: sound waves, R2: waveform, RS: sound wave, VCC: voltage

### BEST MODE FOR CARRYING OUT THE INVENTION

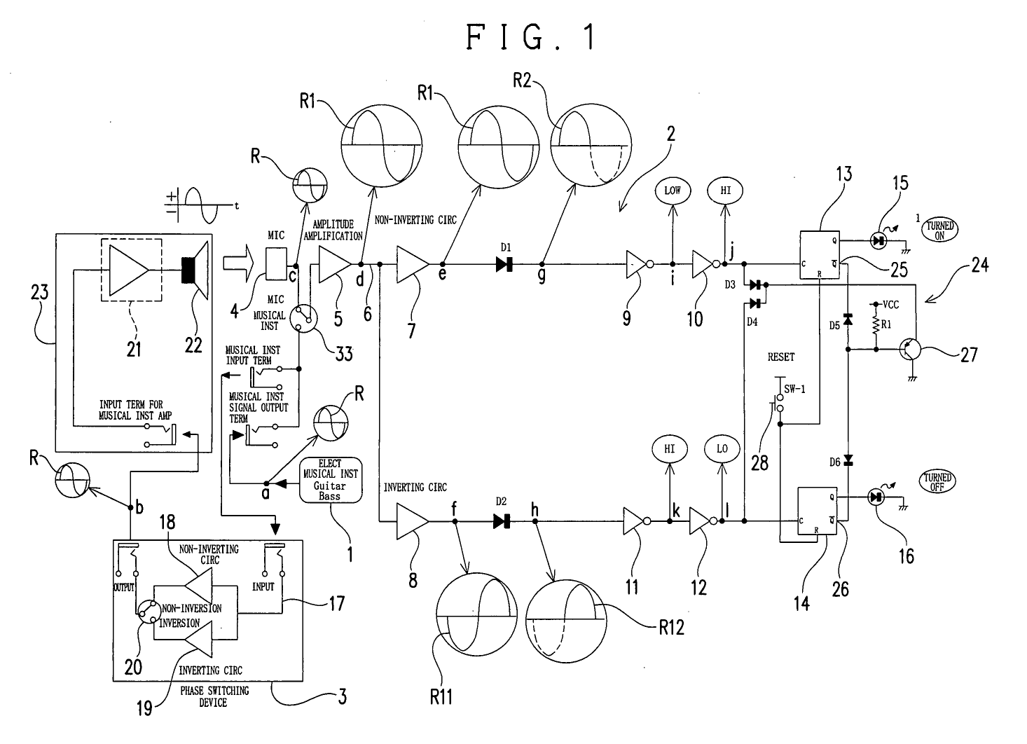

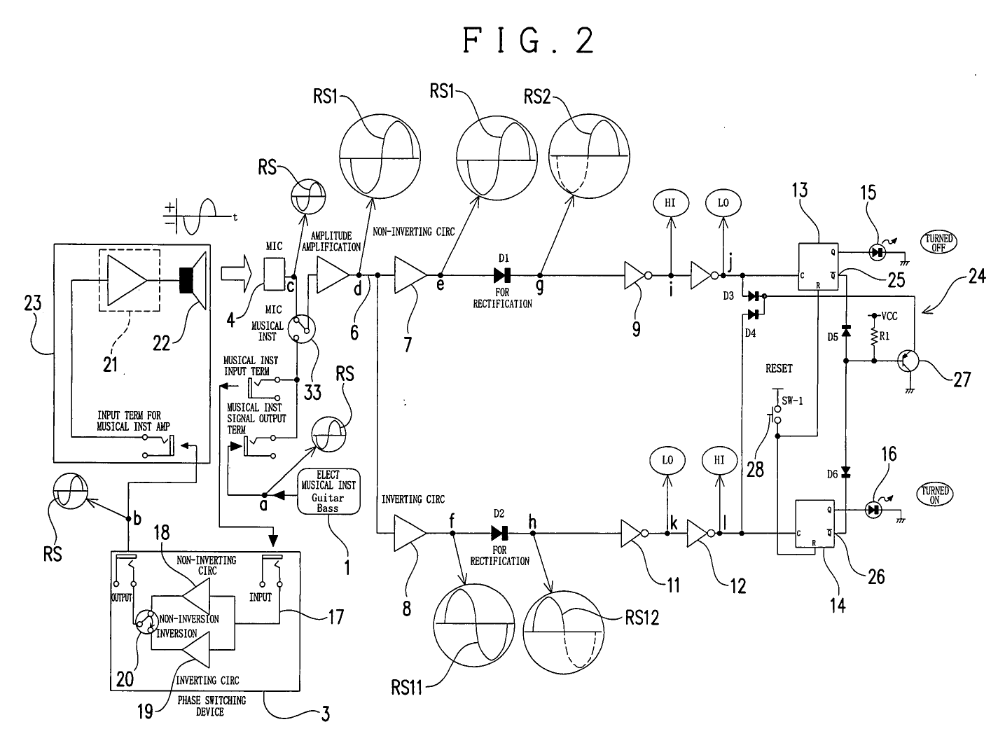

A phase switching device in an electric musical instrument (specifically, an electric stringed instrument, or an electric musical instrument including a musical instrument amplifier), such as an electric guitar or an electric bass guitar, is shown in FIGS. 1 and 2. The phase switching device includes a detection means 2 that detects whether a sound wave transmitted from the electric musical instrument 1 has a positive phase or a negative phase and a phase inverting means 3 that inverts the phase of the sound wave from the electric musical instrument 1 by 180° to become a positive phase when a result of detection performed by the detection means 2 is a negative phase.

The detection means 2 includes: a non-inverting circuit 7 connected to an input line 6 to which a sound wave from the electric musical instrument 1 is input through a microphone 4 and an amplitude amplifier 5; an inverting circuit 8 which branches from the input line 6 and is connected thereto and is connected in parallel with the non-inverting circuit 7; rectifier diodes D1 and D2 respectively connected to output portions of the non-inverting circuit 7 and inverting circuit 8; two inverter circuits 9, 10, 11, and 12 respectively connected in series to each other so that signals rectified in the rectifier diodes D1 and D2 can be inverted to be output; flip-flop circuits 13 and 14 respectively connected to output portions of the inverter circuits 10 and 12 located at the output side; and two light emitting diodes 15 and 16 that are turned on or off by output signals from the flip-flop circuits 13 and 14.

The phase inverting means (phase switching unit) 3 includes: a non-inverting circuit 18 connected to an input line 17 to which the sound wave from the electric musical instrument 1 is input; an inverting circuit 19 connected in parallel with the non-inverting circuit 18; and a switching switch 20 provided to output only one of output signals from the non-inverting circuit 18 and the inverting circuit 19.

A musical instrument amplifier 21 for amplifying a signal, which is output after being switched by the switching switch 20, and outputting the signal to a side of the detection means 2 is provided at an output side of the phase inverting means 3. The musical instrument amplifier 21 is provided in a speaker mounting amplifier 23 with a speaker for outputting a sound wave mounted therein. However, the musical instrument amplifier 21 may be provided separately from the speaker mounting amplifier 23.

The detection means 2 includes a detection state holding means 24 that holds a corresponding detection state so that subsequent detection is not performed (until a reset signal is input) in the case when the detection means 2 detects the positive phase or the negative phase of a sound wave to turn on the light emitting diode 15 or 16. However, the detection means 2 may also be configured such that a detection operation cannot be performed only within a time set by a timer circuit, for example. The flip-flop circuits 13 and 14 are initialized by pressing the reset switch 28 shown in FIG. 1, such that the detection means 2 returns to a state where the positive phase or the negative phase of a sound wave can be detected.

Each of the flip-flop circuits 13 and 14 is a D flip-flop circuit which operates when a rising voltage of a clock signal exceeds a threshold value by an input sound wave to thereby output a high signal and turn on the light emitting diode 15 or 16. The detection state holding means 24 includes: an output terminal 25 or 26 that is provided at an output side of the D flip-flop circuit 13 or 14 in order to invert a high-level output, which is set before application of a rising voltage, to a low-level output by applying the rising voltage; and a transistor 27 that is connected between the output terminal 25 or 26 and an output portion of the inverter circuit 10 or 12 and is turned on by inversion to the low-level output so that a clock signal input to the flip-flop circuit 13 or 14 can flow to the ground. D3 and D4 shown in FIG. 1 represent backflow preventing diodes for preventing a current from flowing from a side of the transistor 27 to the output portion of the inverter circuit 10 or 12. Similarly, D5 and D6 represent backflow preventing diodes for preventing a current from flowing from the output terminal 25 or 26 to the side of the transistor 27.

A process in which the detection means 2 detects whether a sound wave transmitted from the electric musical instrument 1 has a positive phase or a negative phase will be described in the order.

First, when the electric musical instrument 1 connected to a musical instrument signal output terminal through a cord is played, a sound wave (a sign curve with a positive phase; only one period is shown in the drawing in which a vertical axis indicates an amplitude and a horizontal axis indicates a time) R is generated at an ‘a’ point in FIG. 1 and the same sound wave R is output through the phase switching unit 3 (refer to a ‘b’ point). The sound wave R is output from the speaker 22, the sound wave R at a ‘c’ point when the sound wave R is received in the microphone 4 is amplified by the amplitude amplifier 5. As a result, the sound wave R changes to a sound wave R1 at a ‘d’ point. The amplified sound wave R1 becomes a sound wave R1 (a state without a change) at an ‘e’ point and a sound wave R11 (a sign curve with a negative phase) inverted by 180° at an ‘f’ point through the non-inverting circuit 7 and the inverting circuit 8. A negative waveform is cut (‘g’ point; a waveform R2) through the rectifier diode D1 from an ‘e’ point. Then, the signal level changes to ‘Low’ at an ‘i’ point and to ‘High’ at a ‘j’ point through the inverter circuits 9 and 10. As a result, a ‘High’ signal is output from the flip-flop circuit 13 to turn on the light emitting diode 15, such that it can be notified that the sound wave has a positive phase. In addition, a negative waveform is cut (‘h’ point; a waveform R12 delayed by ½ wavelength from the waveform at the ‘g’ point) through the rectifier diode D2 from an ‘f’ point. Then, the signal level changes to ‘High’ at a ‘k’ point and to ‘Low’ at an ‘l’ point through the inverter circuits 11 and 12. As a result, a ‘Low’ signal is output from the flip-flop circuit 14, such that the light emitting diode 16 is not turned on but is still in an off state. In addition, the flip-flop circuits 13 and 14 are initialized by pressing the reset switch 28, such that it can be detected whether the sound wave transmitted from the electric musical instrument 1 has a positive phase or a negative phase.

When the output terminal 25 of the flip-flop circuit 13 changes to the ‘Low’ level by input of the first sound wave, the transistor 27 changes to an electrically conductive state by a voltage VCC applied to a base of the transistor 27. Then, the ‘High’ signal output from the ‘j’ point or ‘l’ point drops to the ground through the rectifier diode D3 or D4 by the transistor. As a result, the ‘High’ signal is not supplied to the flip-flop circuit 13 or 14 and the ‘on’ state of the light emitting diode 15 or 16 is not changed.

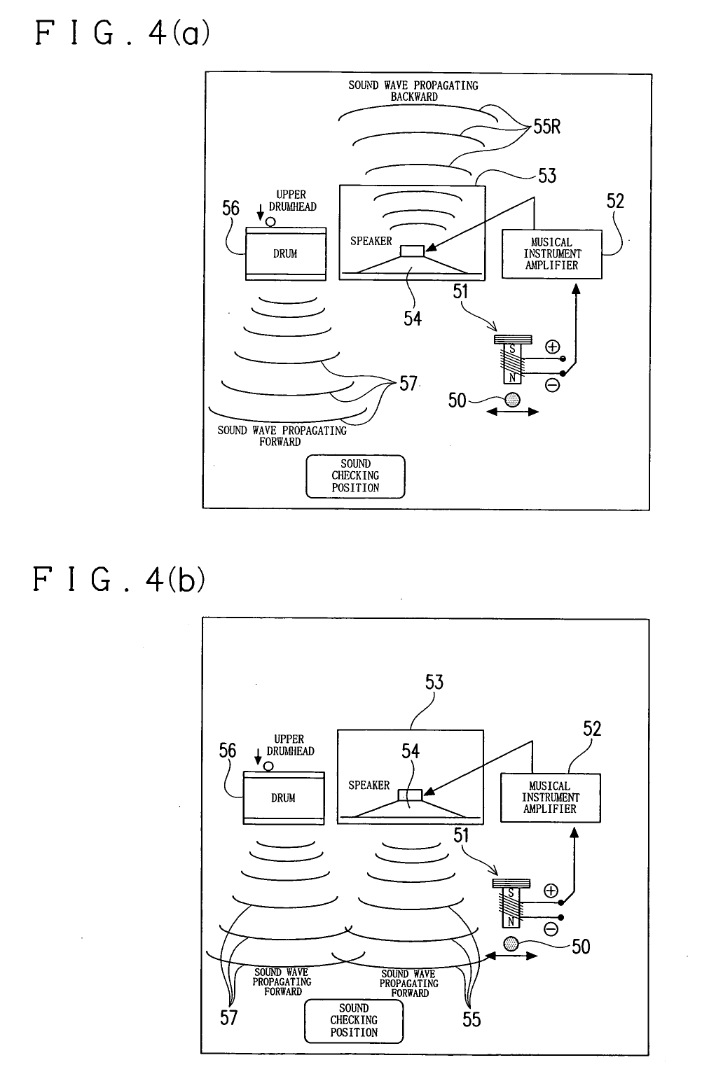

Then, when the electric musical instrument 1 connected to the musical instrument signal output terminal through a cord is played, a sound wave (sign curve with a negative phase; only one period is shown in the drawing) RS is generated at the ‘a’ point in FIG. 2 and the same sound wave RS is output through the phase switching unit 3 (refer to the ‘b’ point). The sound wave RS is output from the speaker 22, the sound wave RS at the ‘c’ point when the sound wave RS is received in the microphone 4 is amplified by the amplitude amplifier 5. As a result, the sound wave RS changes to a sound wave RS1 at the ‘d’ point. The amplified sound wave RS1 becomes a sound wave RS1 (a state without a change) at the ‘e’ point and a sound wave RS11 (a sign curve with a negative phase) inverted by 180° at the ‘f’ point through the non-inverting circuit 7 and the inverting circuit 8. A negative waveform is cut (‘g’ point; a waveform RS2 delayed by ½ wavelength from the waveform at the h point) through the rectifier diode D1 from the ‘e’ point. Then, the signal level changes to ‘High’ at the ‘i’ point and to ‘Low’ at the ‘j’ point through the inverter circuits 9 and 10. As a result, a ‘Low’ signal is output from the flip-flop circuit 13, such that the light emitting diode 15 is not turned on but is still in an off state. In addition, a negative waveform is cut (‘h’ point, a waveform RS12) through the rectifier diode D2 from the ‘f’ point. Then, the signal level changes to ‘Low’ at the ‘k’ point and to ‘High’ at the ‘l’ point through the inverter circuits 11 and 12. As a result, a ‘High’ signal is output from the flip-flop circuit 14 to turn on the light emitting diode 16, such that it can be notified that the sound wave has a negative phase. In this case, although not shown in FIG. 2, a sound wave 55R propagating backward from the speaker 54 (in FIG. 2, a sound wave propagating toward a left side (backside) of the speaker 22) is output as shown in FIG. 4(a). In addition, the flip-flop circuits 13 and 14 are initialized by pressing the reset switch 28, such that it can be detected whether the sound wave transmitted from the electric musical instrument 1 has a positive phase or a negative phase. In addition, when it is determined that the sound wave has a negative phase, the phase of the sound wave can be switched to a positive phase by switching the switching switch 20 from a non-inverting side to an inverting side (switching the switching switch 20 as indicated by an arrow). When this is checked, the light emitting diode 15 is turned on by pressing the reset switch 28.

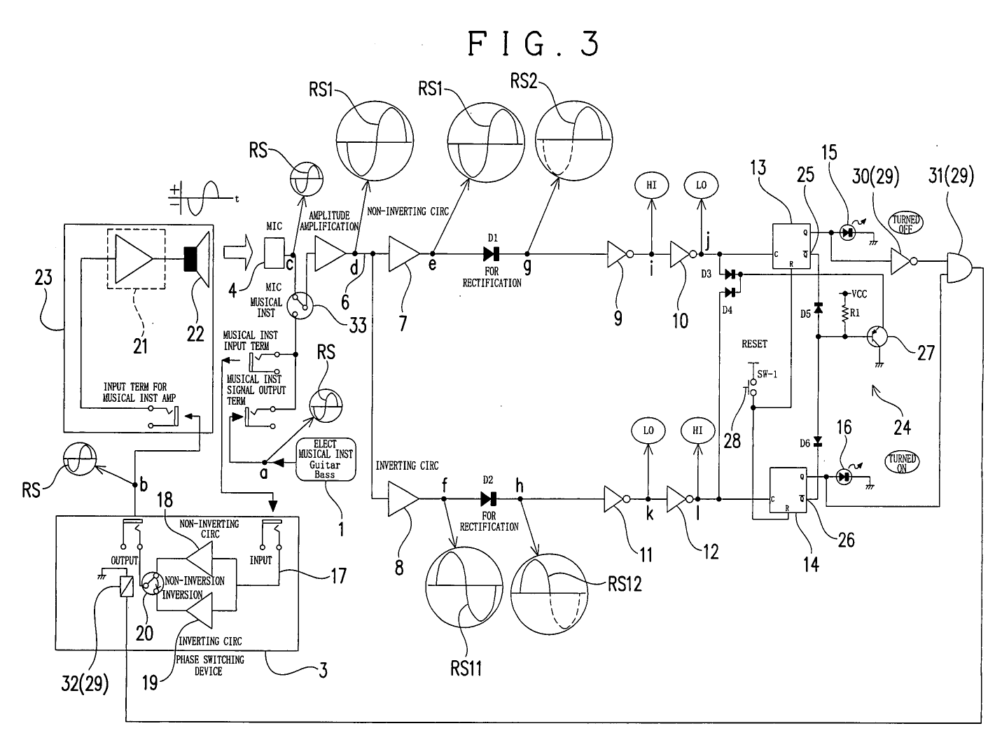

As shown in FIG. 3, provided between the detection means 2 and the phase inverting means 3 is an inversion operation driving means 29 that causes the phase inverting means 3 to perform an inversion operation on the basis of a detection signal when the result detected by the detection means 2 is a negative phase.

The inversion operation driving means 29 includes: an inverter circuit 30 which inverts and outputs an output signal from the flip-flop circuit 13 on one side (side where a positive phase is detected); an AND circuit 31 to which an output signal from the inverter circuit 30 and an output signal from the flip-flop circuit 14 on the other side (side where a negative phase is detected) are input; and a relay 32 for performing a switching operation of the switching switch 20 by the ‘High’ signal output from the AND circuit 31. However, the inversion operation driving means 29 may have the other configurations.

An operation of the inversion operation driving means 29 when the sound wave RS having a negative phase oscillates will be described with reference to FIG. 3. A ‘Low’ signal is output from the flip-flop circuit 13 on the one side, is converted into a ‘High’ signal by the inverter circuit 30, and is then output to the AND circuit 31. Then, when a ‘High’ signal from the flip-flop circuit 14 on the other side is output to the AND circuit 31, the light emitting diode 16 is turned on and at the same time, a ‘High’ signal is output from the AND circuit 31 to drive the relay 32. By automatically switching the switching switch 20 from a non-inversion side to an inversion side by driving the relay 32, the sound wave RS having a negative phase can be inverted by the phase inverting means 3 such that the sound wave RS have a positive phase. In order to check that the negative phase has been switched to the positive phase, detection is performed again by the detection means 2 by pressing the reset switch 28. In the case shown in FIG. 3, the light emitting diodes 15 and 16 are provided to check whether a sound wave has a positive phase or a negative phase. However, the light emitting diodes 15 and 16 may not be provided. In addition, although the two light emitting diodes 15 and 16 shown in FIGS. 1 to 3 are provided so that operation failure of the two light emitting diodes 15 and 16 can also be checked, one light emitting diode may be provided so as to be turned on only in the case when the sound wave has a negative phase. Alternatively, one light emitting diode may be configured to emit light in different colors corresponding to a positive phase and a negative phase. In addition, a character display plate capable of performing character display or a sound device that performs notification with a sound may also be provided instead of the light emitting diode.

Reference numeral 33 shown in FIGS. 1 to 3 represents a switching switch capable of performing switching between a state, in which a sound wave from the speaker 22 is received in the microphone 4 and is then input to the detection means 2, and a state in which a sound wave from the electric musical instrument 1 is directly input to the detection means 2. However, the switching switch 33 may not be provided.

In addition, in the configurations shown in FIGS. 1 to 3, the light emitting diode 15 or 16 is turned on by a rising signal at the ‘g’ point or ‘h’ point. Alternatively, the light emitting diode 15 or 16 may be configured to be turned on by a falling signal.

What is claimed is:

1. A phase switching device in an electric musical instrument comprising:
a detection means that detects whether a sound wave transmitted from the electric musical instrument has a positive phase or a negative phase; and
a phase inverting means that inverts the phase of the sound wave from the electric musical instrument to a positive phase when a result of detection performed by the detection means is a negative phase.

2. The phase switching device in the electric musical instrument according to claim 1,
wherein the detection means includes:
a non-inverting circuit connected to an input line to which a sound wave from the electric musical instrument is input;
an inverting circuit which branches from the input line and is connected thereto and is connected in parallel with the non-inverting circuit;
rectifier diodes connected to output portions of the non-inverting circuit and the inverting circuit, respectively;
two inverter circuits connected in series to each other so that signals rectified in the rectifier diodes can be inverted to be output;
flip-flop circuits respectively connected to output portions of the inverter circuits located at the output side; and
two light emitting diodes that are turned on or off by output signals from the flip-flop circuits.

3. The phase switching device in the electric musical instrument according to claim 1,
wherein the phase inverting means includes:
a non-inverting circuit connected to an input line to which a sound wave from the electric musical instrument is input; an inverting circuit connected in parallel with the non-inverting circuit; and
a switching switch provided to output only one of output signals from the non-inverting circuit and the inverting circuit.

4. The phase switching device in the electric musical instrument according to claim 3, further comprising:
a musical instrument amplifier for amplifying a signal, which is output after being switched by the switching switch, and outputting the signal to a side of the detection means.

5. The phase switching device in the electric musical instrument according to claim 2, further comprising:
a detection state holding means that holds a corresponding detection state until a reset signal is input in the case when the detection means detects the positive phase or the negative phase.

6. The phase switching device in the electric musical instrument according to claim 5,
wherein each of the flip-flop circuits is a D flip-flop circuit which operates when a rising voltage of a clock signal exceeds a threshold value by an input sound wave to thereby output a high signal and turn on the light emitting diodes, and
the detection state holding means includes:
an output terminal that is provided at an output side of each of the D flip-flop circuits in order to invert a high-level output, which is set before application of a rising voltage, to a low-level output by applying the rising voltage; and
a transistor that is connected between the output terminal and an output portion of the inverter circuit and is turned on by inversion to the low-level output so that a clock signal input to each of the flip-flop circuits can flow to the ground.

7. The phase switching device in the electric musical instrument according to claim 1, further comprising:
an inversion operation driving means that is provided between the detection means and the phase inverting means to cause the phase inverting means to perform an inversion operation on the basis of a detection signal when the result detected by the detection means is a negative phase.

8. The phase switching device in the electric musical instrument according to claim 7,
wherein the inversion operation driving means includes:
an inverter circuit which inverts and outputs an output signal from one flip-flop circuit;
an AND circuit to which an output signal from the inverter circuit and an output signal from the other flip-flop circuit are input; and
a relay for performing a switching operation of a switching switch by a ‘high’ signal output from the AND circuit.
